(19) United States
(12) Patent Application Publication
(10) Pub. No.: US 2003/0220858 A1
(43) Pub. Date: Nov. 27, 2003

(54) Method and system for collaborative vendor reconciliation

(76) Inventors: Duc Lam, San Jose, CA (US); Georg Mueller, Pleasanton, CA (US); Chandra (CP) Agrawal, Pleasanton, CA (US); Baby Lingampalli, San Jose, CA (US); Pavel Lopin, Pleasanton, CA (US); Xuan Sunny McRae, Fremont, CA (US)

Correspondence Address: WILSON SONSINI GOODRICH & ROSATI, 650 PAGE MILL ROAD, PALO ALTO, CA, 943041050

(21) Appl. No.: 10/155,797

(22) Filed: May 24, 2002

(51) Int. Cl. G06F 17/60

(52) U.S. Cl. 705/35; 705/34

(57) ABSTRACT

Method and system of exchanging business documents between a set of entities. The set of entities include a plurality of buyers and sellers. Identification information is received from respective entities. The identification information includes at least the names of respected entities from which the identification information is received. The information received from the entities is stored in records in a first storage resource. The records include information to facilitate the sending documents to the entities. Based on similarity between information in respective records, approximate correspondence is determined between records (a) the first storage resource and (b) a second storage resource. The second storage resource is included in an enterprise resource planning (ERP) system belonging to a first entity. Links are established between the respective records based on the approximate correspondence. A request is received to send a document from the first entity to a second entity. A record associated with the second entity is identified in the second storage resource in the enterprise resource planning system. Based on the established link between the record associated with the second entity and the corresponding record in the first storage resource, information in the corresponding record in the first storage resource is obtained to facilitate sending the document to the second entity. Based on information in the corresponding record in the first storage resource, the document is sent from the first entity to the second entity. According to one aspect of the invention, the information received from respective entities includes a postal address and account information. Determining approximate correspondence may comprise determining the degree of correspondence between the postal address and name in the first storage resource and the postal address and name in the second storage resource.

### REFERENCE TO RELATED APPLICATIONS

This application is related to the following United States Patent Applications filed on even date herewith:

System and Method for Electronic Authorization of Batch Checks, application Ser. No. ______, invented by Duc Lam, Matthew Roland and Xuan (Sunny) McRae, attorney docket number 25923.704;

System and Method for Varying Electronic Settlements between Buyers and Suppliers with Dynamic Discount Terms, application Ser. No. ______, invented by Don Holm, Duc Lam and Xuan (Sunny) McRae, attorney docket number 25923.705;

System and Method for Electronic Payer (Buyer) Defined Invoice Exchange, application Ser. No. ______, invented by Duc Lam, Ramnath Shanbhogue, Immanuel Kan, Bob Moore and Xuan (Sunny) McRae, attorney docket number 25923.706;

Method and System for Invoice Routing and Approval in Electronic Payment System, application Ser. No. ______, invented by Bob Moore and Xuan (Sunny) McRae, attorney docket number 25923.707; and

Method and System for Buyer-Centric Dispute Resolution in Electronic Payment System, application Ser. No. ______, invented by Duc Lam, Celeste Wyman and Xuan (Sunny) McRae, attorney docket number 25923.708.

All of the foregoing applications are incorporated herein by reference in their entirety.

### FIELD OF THE INVENTION

This invention relates to the field of software and computer network systems. In particular, the invention relates to electronic systems associated with financial transactions.

### DESCRIPTION OF THE RELATED ART

In traditional paper payment systems, an organization or an individual initiates payment by sending a physical check to the party to whom a debt is owed. The check may be sent in response to an invoice from the party to whom the debt is owed. A newer approach is electronic payment. For example, in the consumer context, individuals may be able to make payment by way of electronic banking. Payment instructions are sent electronically from the individual's computer system to the individual's bank. Payment is then effected by the bank.

Numerous systems now exist relating to accounting and bill payment. For example, computer software is used to track invoices and print payment checks. Payments may be made by wire transfer, with instructions requesting funds of the payer in one financial institution to be transferred to an account of the party to whom payment is to be effected.

Enterprise resource planning (ERP) systems are used for managing the purchases of goods and services. Such systems may have databases of complex and extensive sets of information, such as addresses of various suppliers and similar information related to purchasing. Sellers also use electronic accounting and record keeping systems which may assist in the receipt and tracking receipt of payment for goods and services. Prior systems require considerable amounts of effort to update and maintain, and may lack compatibility with the systems used by parties with whom an organization wishes to engage in transactions. There is thus a need for improved systems to facilitate transactions between buyers and sellers.

### SUMMARY

An embodiment of the invention is directed to a method of exchanging business documents between a set of entities. The set of entities include a plurality of buyers and sellers. Identification information is received from respective entities. The identification information includes at least the names of respected entities from which the identification information is received. The information received from the entities is stored in records in a first storage resource. The records include information to facilitate the sending documents to the entities. Based on similarity between information in respective records, approximate correspondence is determined between records (a) the first storage resource and (b) a second storage resource. The second storage resource is included in an enterprise resource planning (ERP) system belonging to a first entity. Links are established between the respective records based on the approximate correspondence.

A request is received to send a document from the first entity to a second entity. A record associated with the second entity is identified in the second storage resource in the enterprise resource planning system. Based on the established link between the record associated with the second entity and the corresponding record in the first storage resource, information in the corresponding record in the first storage resource is obtained to facilitate sending the document to the second entity. Based on information in the corresponding record in the first storage resource, the document is sent from the first entity to the second entity. According to one aspect of the invention, the information received from respective entities includes a postal address and account information. Determining approximate correspondence may comprise determining the degree of correspondence between the postal address and name in the first storage resource and the postal address and name in the second storage resource.

The information to facilitate sending documents may comprise an electronic mail address of the respective entity. Further, the first entity may comprise a buyer, the second entity a seller and the document may comprise an electronic check according to one embodiment of the invention. Alternatively, the document may comprise an invoice.

According to one implementation, records are loaded from the second storage resource onto a system separate from the enterprise resource planning system. Records loaded onto the system separate from the enterprise resource planning system are then compared with records in the first storage resource to determine the correspondence between records in the first storage resource and the second storage resource. Thus, the correspondence may be determined when the records from the ERP system are not located on the ERP system.

Links may be established in various ways. For example, links maybe established between the respective records based on links previously established between records in (a) the first storage resource and (b) storage devices included in enterprise resource planning (ERP) systems belonging to entities other than the first and second entities. According to another aspect of the invention, links maybe established between the respective records based on recommendations may part other than the first entity and the second entity. Alternatively, links maybe established between respective records based on recommendations received from user or users when insufficient confidence with respect to similarities automatically determined by the system has been received. Further according to one implementation, the approximate correspondences is determined based on a weighted combination of the correspondence between the selected items in the corresponding records in the first storage resource and the second storage resource.

According to one aspect of the invention, a seller's identification information is received from a buyer. The seller's identification information that was received from the buyer is presented to the seller. Edits to the seller's identification information are received from the seller, and the edited seller's identification information is stored in a record in the first storage resource. A link is established between a corresponding record in the buyer's enterprise resource planning system and the record in the first storage resource that includes the seller's edited identification information. According to one implementation, the seller's identification information in the first storage resource is updated based on input from the seller after establishing the link between the corresponding record in the buyer's enterprise resource planning system and the records in the first storage resource that includes the seller's edited identification information.

According to another implementation of the invention, information is received from a buyer regarding an address for billing of transactions and an address for shipping goods in the transactions. Information is also received from the buyer regarding a definition of an invoice to be submitted to the buyer for transaction. The information from the buyer is stored in the first storage resource, and a transaction is effected between a seller and the buyer using the information from the buyers stored in the first storage resource.

Another embodiment of the invention is directed to a system for exchanging business documents between a set of entities. The set of entities includes a plurality of buyers and sellers. The system includes a first storage resource and logic that receives identification information from the respective entities. The identification information includes at least the names of the respective entities from which the identification information is received. The system also includes logic that stores the information received from the entities in records in the first storage resource. The records include information to facilitate sending documents to the entities. The system also includes logic that, based on similarity between information and in respective records, determines approximate correspondence between records in (a) the first storage resource and (b) a second storage resource. The second storage resource is included in an enterprise resource planning (ERP) system belonging to a first entity. The system includes logic that establishes links between the respective records based on approximate correspondence.

Logic included by the system receives a request to send a document from the first entity to the second entity, and logic included by the system identifies a record associated with the second entity in the second storage resource in the enterprise resource planning system. The system further includes logic that obtains information in the corresponding record in the first storage resource to facilitate sending the document to the second entity based on the established link between the record associated with the second entity and a corresponding record in the first storage resource. Logic in the system sends the document from the first entity to the second entity based on information in the corresponding record in the first storage resource.

An embodiment of the invention is directed to a method for effecting an electronic financial transaction between a first entity and a second entity. A payment identification for the first entity is stored and the payment identification is associated with a public identification of the payment identification. A request is received from the second entity to make a payment to the first entity. The request includes a second public identification of the payment identification which approximately corresponds to the first public identification. The second public identification is associated with the first identification. Based on such associating, payment is effected electronically from the second entity to the first entity in accordance with the payment identification of the first entity.

According to one implementation, the first entity may represent a vendor, and the second entity may represent a customer of the vendor. The method may be implemented so that the first public identification comprises a postal address of a vendor as maintained by the vendor and the second public identification comprises the postal address of the vendor, as maintained by a customer of the vendor.

Another embodiment of the invention is directed to a method for effecting electronic payment between a first entity and a second entity including storing an account identification of the first entity. The account identification is associated with a first postal address. A request is received from the second entity to make payment to the first entity. The request includes an identification of a second postal address which approximately corresponds to the first postal address. The second address is associated with the first postal address and payment is effected electronically from the first entity to the account corresponding to the account identification stored for the first entity.

According to one embodiment of the invention, the second entity is provided with a set of possible addresses that may correspond approximately with the second postal address. The set of possible addresses includes the first postal address. A selection is received from the first entity of the first postal address from among the set of possible addresses. The associating of the second postal address with the first address is performed in response to the receipt of such selection from the second entity.

According to one implementation, the second address is automatically associated with the first postal address if a set of components of the first postal address and the second postal address match greater than a particular threshold. According to another embodiment of the invention, the first postal address includes fields of: a vendor name; a zip code; a portion comprising one of, (a) a street address or (b) a post office box number; a taxpayer identification number (TIN) number and a data universal numbering system (DUNS) number. According to various embodiments of the invention, various subsets or supersets of the foregoing may be included in the postal address. For example, the postal address may further include a field of a department name or a field of a business unit. The first and second postal address may be associated based on unstructured pattern matching. Alternatively, the first and second address may be associated based on a set of rules, for example, by matching various subcombinations of portions of the postal address and, according to one implementation, weighting such subcombinations and/or weighting such portions differently.

One embodiment of the invention is directed to a system for effecting electronic payment between a set of entities associated with vendors and a set of entities associated with purchasers. The system includes a database. For entities associated with vendors, the database includes a set of records including, for a respective entity associated with a purchaser, remittance addresses of vendors. For entities associated with vendors, the database also includes a set of records, each including a remittance address and an identifier of a financial account. The database further includes links between (a) the respective records for the entity associated with the purchaser and (b) the respective records associated with vendors. The links link records with corresponding remittance addresses.

Such a system, according to one embodiment of the invention, includes computer readable code that establishes the links based on correspondence between the respective addresses in the respective records for the entity associated with the purchaser and the respective entities associated with vendors. Such an exemplary system further includes computer readable code that receives a request from an entity associated with a purchaser to make payment to a vendor. The request includes a selection of a remittance address from among the respective records for the entity associated with the purchaser.

Such an embodiment may further include computer readable code that effects payment to a financial account based on the link between (a) the respective record for the entity associated with the purchaser and (b) the respective record for the entity associated with the vendor. The record for the entity associated with the purchaser corresponds to the selected remittance address and the record for the entity associated with the vendor has a remittance address corresponding to the selected remittance and an identifier of the financial account.

According to one embodiment of the invention, the database includes a first database with respective entries associated with the vendor located on a server. The database also includes two databases associated with respective entities associated with the purchaser. The first of the two databases associated with respective entities associated with the purchaser may be located on the server and second of such two databases, according to such an embodiment, may be located on the purchaser's enterprise resource planning (ERP) system.

### BRIEF DESCRIPTION OF THE DRAWINGS

FIG. 1 is a block diagram of an electronic payment system with resources for automatic reconciliation between databases, according an embodiment of the invention.

FIG. 2 is a block diagram of an electronic payment system with databases and electronic check distribution according to an embodiment of the invention.

FIG. 3 is a flow diagram showing an electronic payment process according to an embodiment of the invention.

FIG. 4 is a block diagram of an electronic transaction system showing databases, match generation, enrollment, and link architecture according to an embodiment of the invention.

FIG. 5 is a flow diagram showing synchronization of vendor list and matching according to an embodiment of the invention.

FIG. 6 is a block diagram showing data relationships according to an embodiment of the invention.

FIG. 7 is a block diagram showing address relationships according to an embodiment of the invention.

FIG. 8 is a schematic representation of a user interface according to an embodiment of the invention.

FIG. 9 is a schematic representation of a set of rules for matching identification information according to an embodiment of the invention.

FIG. 10 shows a system for electronic payment according to an embodiment of the invention.

### DETAILED DESCRIPTION

An embodiment of the invention is directed to a system that helps to facilitate exchange of business documents between parties. The respective parties may not have completely accurate data about each other and about how to send documents or other information to each other. Aspects of the invention help to reconcile information that the parties have about each other with information in a global storage resource. The global storage resource helps to allow for exchange of business documents between the parties.

Various entities use enterprise resource planning (ERP) systems to help conduct business activities. Certain aspects of the invention help to reconcile information that entities, in their enterprise resource planning systems, maintain about other parties. One aspect of the invention helps to reconcile the information in enterprise resource planning systems with information stored in a global resource with limited intervention in the enterprise resource planning system. According to one implementation, information is uploaded from the enterprise resource planning system regarding parties with whom a party wishes to conduct business transactions or to exchange documents. The information is uploaded to a system other than the enterprise resource planning system. The information from the records may include contact or payment identification information, such as account numbers or payment addresses, and this uploaded information is matched with corresponding entries in the global storage resource.

The matching may take place through various approaches. For example, matches may be suggested based on the amount of correspondence between the respective records from the enterprise resource planning system and the respective record in the global storage resource. For example, a determination may be made regarding the amount of matching between different fields of a record that has been uploaded with corresponding fields in the global storage resource. In one aspect of the invention, it is determined whether there is a match, and the degree of the match, between the party name, zip code, street address and other aspects of the entry and the respective records. The amount of matching may be displayed and presented for a user to determine whether to create a link between the corresponding records. Alternatively, based on a confidence level regarding the matching, the link may be automatically established between the respective records.

A knowledge-based historical approach may be used to determine matches. For example, matches may have already been established between entries in other enterprise resource planning databases and corresponding entries in the global storage resource. Based on these matches, another party's entries in its enterprise resource planning system may be matched with entries in the global storage resource if such entries in the other party's enterprise resource planning system are the same as the matched entries in the other party's enterprise resource planning system.

If matches are not found by such approaches, other approaches may be used. For example, according to one approach, a third party service may provide links between entries in the enterprise resource planning system records and the global storage resource. Such third party service may use the above or other techniques to help identify candidates for links. Another approach is for a user of a respective system to select and enter links by way of a user interface. Such user interface may include presentation of potential matches for the links. The presentation may include data regarding confidence of the match and different aspects of the confidence of the match.

If there is not an entry for an entity in the storage resource, an entry may be established. Such entry may be established in response to another party trying to establish a link with such party. For example, a buyer may have an entry in its own system for a seller. However, when the buyer attempts to establish a link between the buyer's entry in its system and a corresponding entry in the storage resource, it may be determined that an entry does not exist in the storage resource for the seller. The seller may be contacted to establish an entry in the storage resource. When the seller is contacted, it may be provided information from the buyer, such as what the buyer believes to be the seller's contact information. The seller is then able to edit this information or provide other information for the global storage resource. After establishing an entry response to the request, the seller can be contacted by other entities using the storage resource.

The global storage resource may be used for various business purposes. For example, buyers may access information regarding sellers in order to send payment or payment information to sellers. Sellers may access information regarding buyers in order to send shipments and invoices to buyers. Other exchanges of business documents may also be made using the storage resource. Parties may update their contact information or other information in the storage resource. Then other parties wishing to use the information in the storage resource may access the updated information based on previously established links.

One implementation of the invention is directed to a method for effecting payment between buyers and vendors. Buyers have computer systems including information about the vendors to whom the buyers owe payment. For example, buyers may have addresses of the vendors to which payment would be mailed if the payment were to be made by mail. Buyers may store this information on systems such as enterprise resource planning (ERP) systems. Vendors also have corresponding information about themselves on their respective computer systems, for example, the addresses to which they expect that payment would be sent, if were payment were mailed. Unfortunately, the addresses that the buyers maintain for the vendors may not correspond exactly or accurately with actual addresses of the vendors, or the addresses that the vendors store for themselves on their computer systems. For example, the user maintaining the information for the buyer may have typed the vendor's address differently from the way the address is maintained in the vendor's system. One implementation of the invention includes a method of effecting payment, including determining the correctly matching addresses of the vendors maintained by the buyers and the corresponding addresses of the vendors maintained by the vendors.

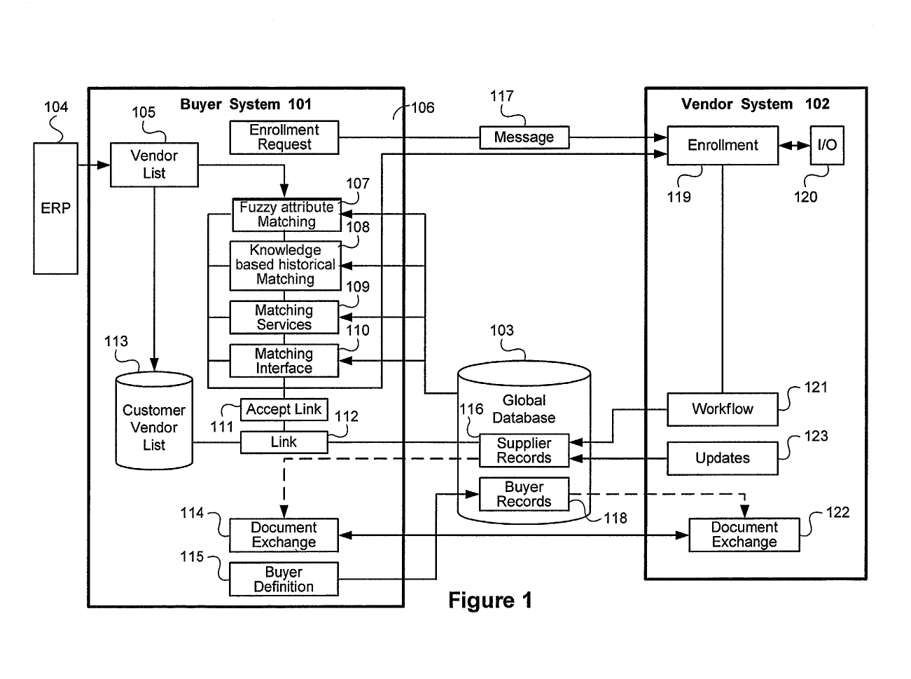

FIG. 1 is a block diagram of an electronic payment system with resources for automatic reconciliation between databases, according an embodiment of the invention. FIG. 1 includes buyer system 101, vendor system 102, global database 103 and ERP system 104. Buyer system 101 includes vendor list 105, customer vendor list 113, fuzzy attribute matching logic 107, knowledge-based historical matching logic 108, third party matching service logic 109 and interactive matching interface 110. Buyer system 101 also includes accept link logic 111 and link 112. Further, buyer system 101 includes enrollment request logic 106, document exchange logic 114 and buyer definition logic 115.

The following are some of the components of vendor system 102. Vendor system 102 includes enrollment logic 119, input output (I/O) 120 and workflow logic 121. Also included on vendor system 102 is updates logic 123 and document exchange logic 122. Enrollment logic 119 is coupled with input output (I/O) 120 and workflow logic 121. Enrollment logic 119 is coupled with enrollment request 106 of buyer system 101, which forwards message 117, and also is coupled with logical blocks 107, 108, 109 and 110 on buyer system 101. Workflow 121 and updates 123 are coupled with supplier records 116 of global database 103. Document exchange 122 is coupled with document exchange 114 of buyer system 101 and with buyer records 118 of global database 103.

Global database 103 includes supplier records 116 and buyer records 118. Supplier records 116 are coupled with the customer vendor list records 113 of buyer system 101 via links 112. Supplier records 116 are accessed by document exchange 114. Buyer records 118, which are coupled with buyer definition logic 115 of buyer system 101, are accessed by document exchange 122 of seller system 102.

Buyer system 101 includes at least four logical blocks which are involved with matching and are connected in the following order in one possible implementation: fuzzy attribute matching logic 107 is coupled with knowledge-based historical matching logic 108; knowledge-based historical matching logic 108 is coupled with third party matching service logic 109; and third party matching service logic 109: is coupled with interactive matching interface logic 110. Accept link logic 111 is coupled with fuzzy attribute logic 107, knowledge-based historical matching logic 108, matching service logic 109 and interactive matching interface logic 110. Link 112 is coupled with accept link logic 111 and provides a link between customer vendor list 113 and respective records and supplier records 116 of global database 103. Vendor list 105, which is received from ERP system 104, is stored in customer vendor list 113 on buyer system 101, and is provided as input to matching logic blocks 107, 108, 109 and 110. Enrollment request logic 106 is coupled with enrollment logic 119 of vendor system 102 via, for example, message 117.

The system shown helps to facilitate establishment of links between records in an enterprise resource planning system and corresponding records in a storage resource. For example, here, links are established between records in enterprise resource planning system 104 and the corresponding records in global database 103. In this example, the links established by establishing links between items in customer vendor list 113, which is a mirror of information in records in enterprise resource planning system 104, and the corresponding records in global database 103. Information from the vendor list 105, which is obtained from enterprise resource planning system 104, is compared with corresponding information in global database 103.

Such information is compared according to various processes, in different aspects of the invention. For example, a fuzzy attribute matching is applied first, according to one implementation, and such matching is provided with the assistance of fuzzy attribute matching logic 107. Fuzzy attribute matching involves determining the degree of correspondence between records from the enterprise resource planning system and potentially corresponding records in global database 103. According to one implementation, confidence levels are established, and based on the confidence levels, matches are automatically established between items in the a customer vendor list 113 and potentially matching the entries in global database 103. According to one aspect of the invention, if a match is not made by fuzzy attribute matching logic 107, a match is attempted to be found using knowledge-based historical matching logic 108. Under knowledge-based historical matching 108, links are established based on whether links have previously been established between (a) entries in global database 103 and (b) similar entries in other enterprise resource planning system, or other systems belonging to other entities. Such history of prior matches may be stored in global database 103, according to one implementation.

If matches are not made based on such fuzzy attribute matching or knowledge-based historical matching, other approaches may be used, some of which include some degree of human interaction. For example, matching service logic 109 facilitates matching that is made by a third party service. Such matching service logic 109 provides an interface for such a service to select matches and establish links based on such matches between entries in customer vendor list 113 and global database 103. The third party matching service may apply automatic techniques such as those used in fuzzy matching logic 107 and knowledge-based matching 108 in order to establish candidates for matches. Then a selection is made based on such candidates and other experience. Alternatively, matching interface 110 allows for a user of buyer system 101, which may be an employee of the corresponding buyer organization, to select matches for which links will be established. The interface provided in matching interface 110 may provide potential candidates for matches and may provide the user with information regarding confidence of such matches and other information that helps the user to make an informed judgment as to whether a match between entries should be established. When a match is selected, either through an automatic process, such as through fuzzy attribute matching 107 or knowledge-based historical matching 108 or other process, link 112 is established by accept link logic 111. Link 112 then forms a correspondence between an entry and customer vendor list 113 and a corresponding record in supplier records 116, which is included in global database 103.

If, through the matching processes, it is determined that an entry likely does not exist and global database 103 for a particular entity, an attempt may be made to enroll the unlisted entity in global database 103. Thus, a communication occurs between enrollment logic 119 of vendor system 102 and matching blocks 107, 108, 109 and 110 to manually request enrollment of the vendor that was not identified in the matching process. Such request may include information provided by buyer system 101 regarding the vendor. The information provided by the buyer helps to pre populate a form that the vendor completes. The information provided by the buyer also helps the vendor to determine whether the buyer has incorrect information regarding the vendor and helps to save the vendor a certain amount of effort in filling out the form. Thus, enrollment logic 119 is coupled with input output (I/O) 120 to allow for appropriate personnel in the vendor's organization to complete the information for a record in global database 103 for the vendor. Such record may be further completed through other interaction with selected personnel in the corresponding vendor system 102 through a workflow process 121.

Once the information has been obtained from the vendor, it is entered into supplier records 116 in global database 103. Later, updates may be made to this information via appropriate logic, such as updates logic 123, which is coupled with supplier records 116. After links have been established with such supplier records 116, the updated information is then available for use by other parties, even though they may not have received a direct message from vendor system 102 that the information has been updated. This, certain implementations of the invention help to save effort and resources that otherwise would be used to inform parties that the vendor's information has been updated.

A buyer can also provide information about itself for use by other parties, such as for use by the vendor to send documents to the buyer. Such information provided by the buyer may include contact information, such as bill to address and ship to address as well as information regarding the form that an invoice for such buyer should take. This information is collected by buyer definition logic 115 and published in buyer records 118, which are located in global database 103.

Buyers and sellers are able to use the records in global database 103, after appropriate links have been established to exchange with each other. For example, via document exchange logic 114, buyer system 101 can obtain information regarding the address which to send payment to vendor system 102. Then appropriate payment documents, such as electronic checks, can then be sent to vendor system 102 using this information. Similarly, vendor system 102 can obtain information regarding how to contact the respective buyer through buyer records 118. Then vendor system 102 can send the appropriate documents, such as an invoice, to the appropriate destination obtained from buyer records 118.

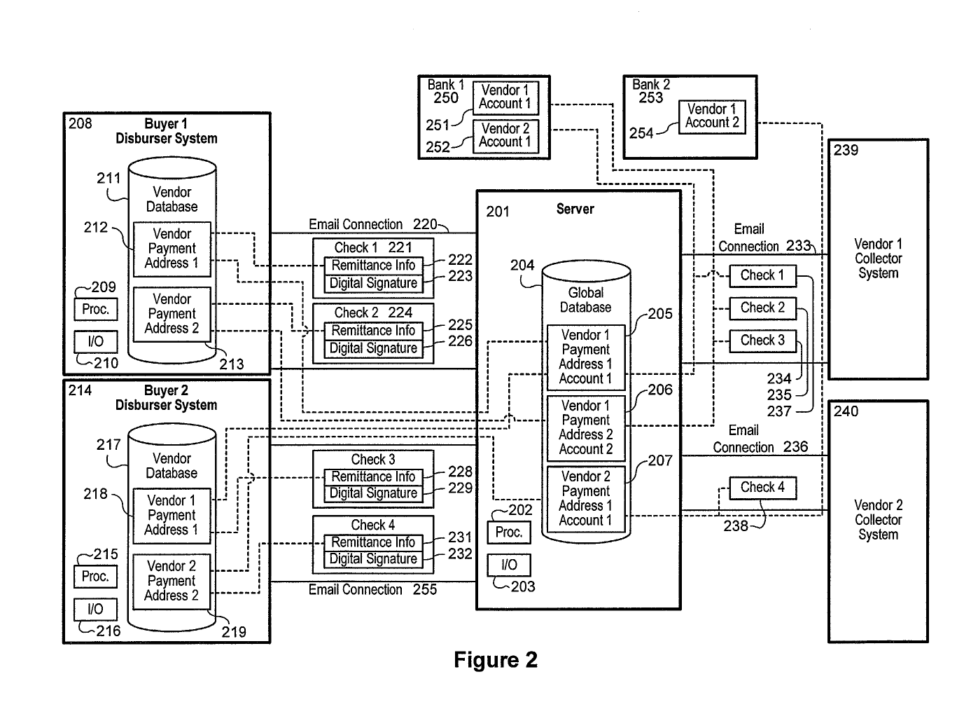

FIG. 2 is a block diagram of an electronic payment system with databases and electronic check distribution according to an embodiment of the invention. Payments are effected between respective buyer disburser systems, such as buyer 1 disburser system 208 and buyer 2 disburser system 214, and respective vendor collective systems, such as vendor 1 collector system 239 and vendor 2 collector system 240. Payments are made via electronic checks such as check 1 (221 and 234), check 2 (224 and 235), check 3 (227 and 237) and check 4 (230 and 238). Payment is effected to banks such as bank 250 and bank 253. Address information stored on a respective buyer disburser systems, such as vendor 1 payment address 212, which is stored in vendor database 211, is used to help route checks and payment based on corresponding information stored in a global database 204 on server 201.

The system depicted includes a buyer 1 disburser system 208, buyer 2 disburser system 214, server 201, vendor 1 collector system 239 and vendor 2 collector system 240. The various systems shown may be implemented on respective servers having electronics and input output. For example, buyer 1 disburser system 208 includes processor 209 and I/O 210, buyer 2 disburser system 214 includes processor 215 and I/O 216, and server 201 includes processor 202 and I/O 203. According to other embodiments of the invention, the respective functionality may be implemented on a single server or other combination of servers, such as a bank of servers or a distributed system implemented in a network, including in various entities located in different parts of the internet, or other distributed network.

Buyer disburser systems include databases of respective vendors with payment addresses, for example as shown here, buyer 1 disburser system 208 includes vendor database 211 with vendor 1 payment address 1 212 and vendor 1 payment address 2 213. Such addresses are used as the remittance address printed on the electronic checks sent to the respective payment entity. The addresses are also linked to a respective entry in global database 204 that contains global information such as the account number for respective payment corresponding to the address. Such links are direct, or indirect, such as through an intermediate database containing entries from the respective customer's vendor data bases. Thus, for example, check 1 221 has remittance information 222 which corresponds to vendor 1 payment address 1 212, and check 2 224 includes remittance information 225, which corresponds to vendor 1 payment address 2 213. These checks are routed based on the payment identification stored in the corresponding entries in global database 204. For example, the corresponding entry in global database 204 corresponding to check 221 is vendor 1 payment address 1 205, which includes account number 1. With the help of such information, check 1 234 is routed such that payment is eventually made to vendor 1 account 1 251 in bank 250.

Different entries in the respective vendor database correspond to different payment identities. For example, vendor 1 payment address 2 213 corresponds to respective entry vendor 1 payment address 2 account 2 206 in global database 204. Thus, check 2 (224 and 235) is appropriately routed to vendor collector system 239, first as shown check to 224 and email connection 220 between buyer 1 disburser system 208 and server 201 and then as shown check 2 235 and email connection 233 between server 201 and vendor 1 collector system 239. Payment is correspondingly effected into vendor 1 account 2 254, based on the corresponding entry in global database 204, which is vendor 1 payment address 2 account 2 206.

Global database 204 is shared between various buyers and is a central location in which vendors' payment information is updated. For example, buyer 2 disburser system 214 has the entry, vendor 1 payment address 1 218 in vendor database 217, which corresponds to vendor 1 payment address 2 account 2 206 in global database 204, which also corresponds to a respective entry in buyer 1 disburser system 208's vendor database 211. Thus, a vendor may, by causing its payment information to be updated in global database 204, have such updated information available to multiple other entities (such as buyers) without having to distribute the information to the vendors separately.

Payment information for other vendors is also stored in global database 204. For example, vendor 2 payment address 1 account 1 207 is stored in global database 204. This entry corresponds to an entry in buyer 2 disburser system 214's vendor database 217, i.e. vendor 2 payment address 1 219. Thus, check 230 effects payment, as shown with check 4 238 to vendor 2's account 1 252 in bank 250.

Electronic checks distributed in the system are encrypted and contain digital signatures 223, 226, 229 and 232, for security purposes. Communication between the systems may be made electronically through email connections, such as email connection 220, email connection 255, email connection 233, and email connection 236. Other protocols other than email may be used to communicate electronic payment information. For example, an EDI (Electronic Data Interchange) system using various protocols may be used. In a system on a single server, email connections may be replaced with internal electronic process communications or other communications representing checks or other forms of payment.

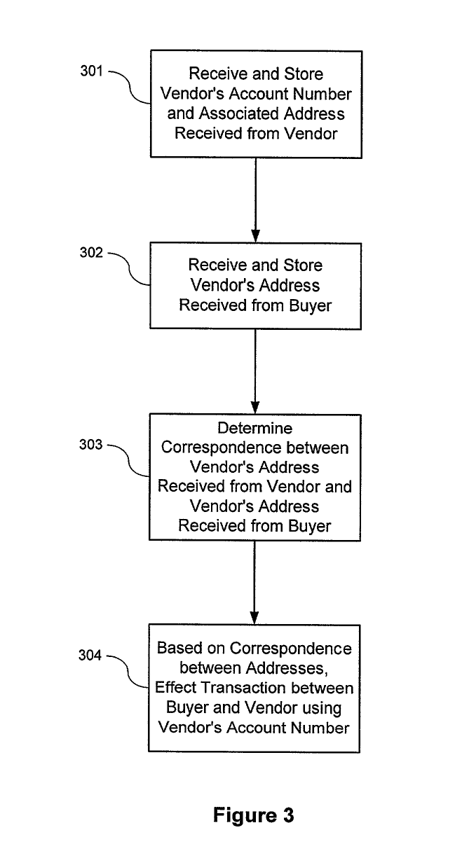

FIG. 3 is a flow diagram showing an electronic payment process according to an embodiment of the invention. An advantage of one implementation the process shown in FIG. 3 is that payment can be effected between a buyer and seller based on their respective, possibly different, versions of the seller's address, after correspondence between those versions is determined. For example, when the buyer recorded the seller's address the buyer may not have recorded the address in the exact same manner as the seller records its address. Thus, an exact match between the respective addresses may not be present. However, by determining a correspondence between the recorded addresses, payment or other transaction between the parties can be effected.

As shown, seller's account number and associated address that are received from seller are received and stored (block 301). The seller's address received from buyer is also received and stored (block 301). A correspondence is determined between the seller's address received from the seller and the seller's address received from the buyer (block 303). Correspondence methods include one or more logics: fuzzy attribute matching, knowledge based historical matching, third party matching service, and interactive matching interface. Based on the correspondence between the addresses, a transaction is effected between the buyer and seller using the seller's account number (block 304).

The process described above may provide advantages where operators in the respective organizations make spelling errors, or other mistakes in typing, or for other reasons do not have exact correspondence between the addresses recorded by the seller and by the buyer, even though such addresses correspond to the same payment identification. The payment identification may represent account, such as a particular bank or other financial account, or division of the seller, or seller organization to which payment is to be effected. By determining a correspondence between such addresses of seller received from buyer and seller, a transaction based on the payment identification of seller can be effected.

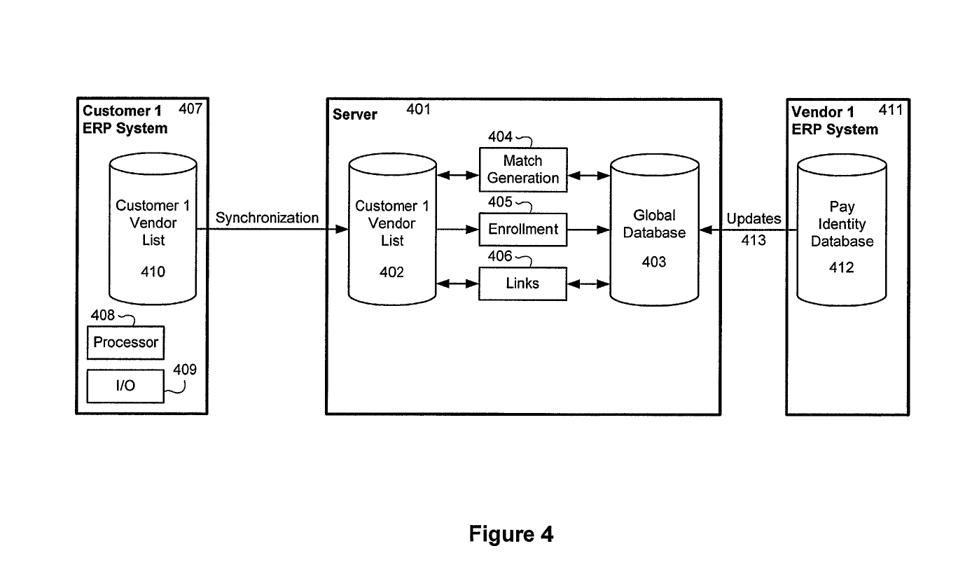

FIG. 4 is a block diagram of an electronic transaction system showing databases, match generation, enrollment, and link architecture according to an embodiment of the invention. FIG. 4 includes customer 1 ERP system 407, server 401 and vendor 1 ERP system 411. According to various implementations, such systems are implemented in various hardware and software architectures, such as shown here, as separate servers with corresponding electronics, such as processor 408 and I/O 409, located in customer 1 ERP system 407. Alternatively, the functionality of the systems is combined into a single server or other computer device. According to various implementations, the respective lists stored in data bases are implemented on separate storage devices, such as hard drives, or alternatively are implemented on a common or shared storage device or other media for storing data.

FIG. 4 helps to illustrate the establishment of correspondence between company information in respective customer's lists and a global database of companies or other entities. Customers' systems have lists of vendor information, based for example on information provided by the customers, such as information accepted by the system from customers. An example of such a list is customer vendor list 401 on customer ERP system 407. A global database based on other sources of the information, such as updates from the vendors' address information and/or account information is stored, such as shown here with global database 403 located on server 401.

A list corresponding to a customer's vendor list is stored also on a server separate from the customer's ERP system, in one implementation, such as shown here with customer 1 vendor list 402 located on server 401. This list is synchronized periodically with customer vendor list 410 located on customer 1 ERP system 407. Links are established between respective entries of a customer vendor list and the global database 403. A customer may have an entry corresponding to a particular vendor in such customer's list and that entry is linked to an entry corresponding to the vendor in the global database. For example, links 406 correspond to links between respective entries in customer 1 vendor list 402 and global database 403. Matches between entries in customer vendor lists 402 and potentially corresponding entries global database 403 are generated in match generation process 404 as shown here. In the match generation process 404, after matches between entries in the customer 1 vendor list 402 and potentially corresponding entries in the global database 402 are generated, links are established based on a subset of such candidate matches between entries in the respective databases.

A corresponding entry is made optionally in global database 403 in an enrollment process 405, such as when an entry in the customer 1 vendor list 402 is not present in global database 403. Such vendor information placed in global database 403 through enrollment 405 is available for subsequent use by customer 1 or other customers, depending on whether such information is designated as a private or a public entry.

An implementation of the system allows entries for respective parties in global database 403 to be edited and/or entered by those respective parties. For example, according to one implementation the vendors' own information is stored in the vendors' respective servers, such as their ERP systems, as shown here with vendor 1 ERP system 411, which has pay identity database 412. The database is optionally used to update global database 403 through updates 413 on a periodic basis. The updated information in global database 403 is then available for various customers of vendor 1, without vendor 1 or its system necessarily being required to separately notify those customers of the change.

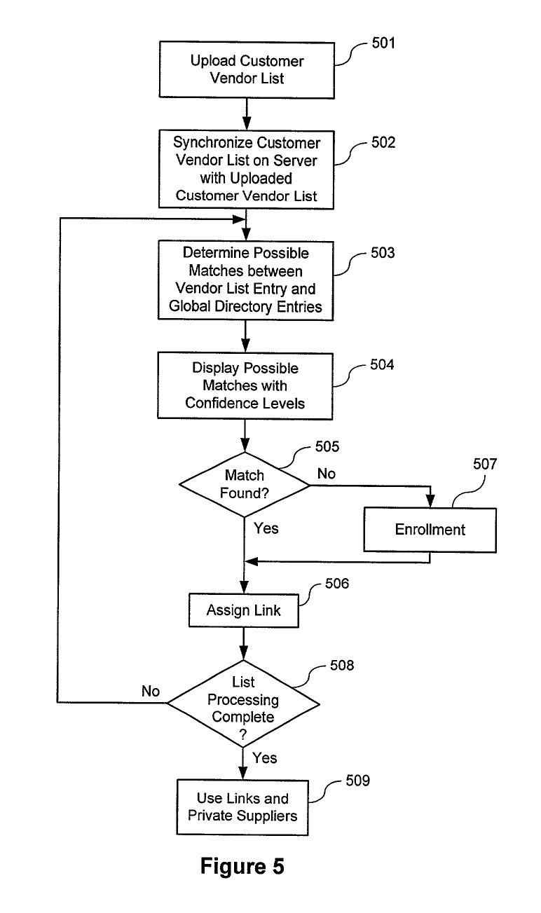

FIG. 5 is a flow diagram showing synchronization of vendor list and matching according to an embodiment of the invention. Such a process may be implemented on a configuration such as that shown in FIG. 4, however it may also be implemented in other types of systems or architectures. A customer's list of vendors is uploaded to a system (block 501), such as where a customer maintains a separate list of its vendors in a storage system separate from a central system. For example, as shown in FIG. 4, vendor information from customer 1 vendor list 410 may be uploaded onto server 401. Customer vendor information on the server is synchronized with the uploaded customer vendor list (block 502).

A determination is made of possible matches between vendor list entries and global directory entries. For example, as shown in FIG. 5, for a particular vendor list entry, possible matches are determined between the vendor list entry and global directory entries (block 503). Potential matches with corresponding confidence levels are displayed (block 504). For example, if matches are determined based on the correspondence between the spelling of the address and the respective entries, in one implementation a higher confidence is assigned to entries in which the spelling has a greater degree of match between the respective entries. In other implementation other criteria may be used to determine the confidence of the matches between entries. For example, according to various implementations other fields in the respective entries may be compared, such as Taxpayer I.D. Number (TIN). Alternatively, various combinations of fields are compared, and the importance of the field for determining confidence of the match may be weighted differently depending on the probability of respective fields helping to determine a match. In some implementations, the matches are not displayed, and matching is performed automatically.

If a match is found (block 505) a link is assigned between the entry in the customer vendor list and the corresponding entry in the global directory (block 506). Such matching in one implementation is optionally performed automatically based on various rules and/or thresholds of confidence regarding the match.

If a match is not found (block 505), sufficient information may nevertheless be present to enroll the vendor (block 507). Such supplier information is stored in the global database in one implementation. The system, based on customer selection, either establishes the supplier as a private supplier in which case it is not generally available to other customers even though shared in the global database, or alternatively, may be available as a public supplier in the global database, available for access by the system for transactions for other customers. If there is not sufficient information to enroll the supplier in the database, alternative means may be used to effect transactions with the supplier. After a supplier is enrolled, a link can be assigned between the entry in the vendor list and the corresponding entry in the global directory for the supplier (block 506).

According to one implementation, the foregoing is repeated for various entries in the vendor list until the list is completely processed. For example, if list processing is not complete (block 508) possible matches between another vendor list entry and global directory entries are determined (block 503), and the matching process is applied to such entry. After the list processing is complete (block 508), the established links are used, for example, to effect payment transactions between the customer and its respective vendors based on information in the global directory (block 509).

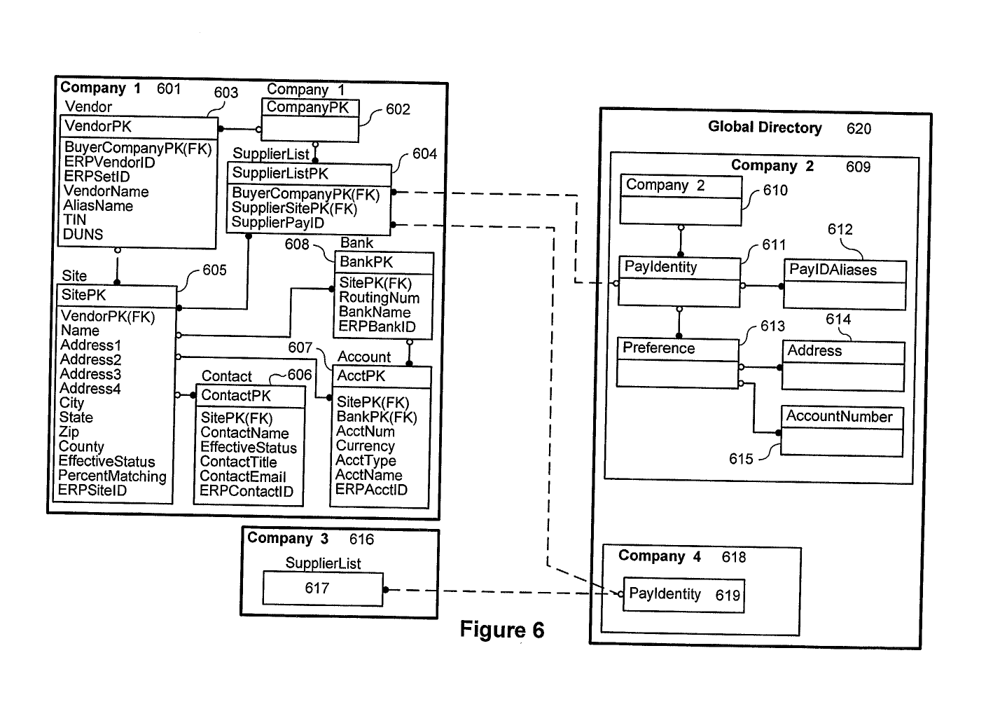

FIG. 6 is a block diagram showing data relationships according to an embodiment of the invention. Information that may be useful for a company's financial transactions is stored in data records associated with the company. These records may contain information that is associated with other companies, and such information is linked to another directory or database containing additional or alternate information about the other company. For example, various companies such as company 1 601 and company 3 616 store information pertinent to their procurement, financial or other transactions, and have links between such information and a global directory 620 which has supplemental information pertinent to such information. For example, here, companies have information regarding their suppliers in one set of records and links are provided between such information regarding the suppliers and global directory 620 which contains further or supplemental information regarding such suppliers. The global directory 620 optionally includes information regarding the suppliers updated by the suppliers' systems, such information includes, for example, accounts and addresses of the suppliers as provided by the suppliers' systems.

In this exemplary data arrangement, records associated with company 1 601 include items such as company 1 root 602, vendor 603, supplier list 604, site 605, contact 606, account 607 and bank 608. These respective records are stored in the company's vendor database, according to one implementation, the company's vendor database is optionally stored on the company's ERP system and is duplicated or synchronized with a vendor database located on a server, such as server 601 as shown in FIG. 6. Solid dots in the drawing at the termination of lines between items represent multiple such items located at the respective solid dot. For example, multiple records of vendor 603 may be associated with company 1 602. Multiple records for supplier list 604 are associated with record company 1 602.

Each record supplier list 604 represents a different payment identity. A payment identity corresponds to a destination for payment. For example, a destination may be a particular account of a vendor, such as a particular account associated with a site, division or department of a vendor. These may be referred to generally as sites. Thus, according to one implementation, each record supplier list 604 corresponds to a record site 605. Similarly, according to one implementation, each supplier record supplier list 604 of company 1 601 corresponds to a separate payment identity in global directory 620. A single company may work with multiple vendors. Thus, record company 1 602 may be associated with multiple records vendor 603. Similarly, a single vendor may have multiple sites for payment. Thus, record vendor 603 is associated with multiple records site 605.

A site has multiple associated items according to one implementation. For example, in one implementation multiple contacts are associated with a single site. Thus, record site 605 is associated with multiple records contact 606. Similarly, multiple accounts may be associated with a single site. Thus, multiple records account 607 may be associated with record site 605. Multiple banks may be associated with a site because of different accounts. Thus, multiple records bank 608 are associated with record site 605. An account is typically located on a single bank. Therefore, record account 607 is associated with a single bank 608.

The following is an example of information that is contained in respective records associated with company 1 601 in exemplary implementations. For example, record vendor 603 includes a key linking it to the company, BuyerCompanyPK(FK); an identity of the vendor as provided by the ERP system, ERPVendorID; an identification of an associated set provided by the ERP system, ERPSetID; the name of the respective vendor, VendorName; an alias for the vendor, AliasName; a taxpayer identification number, TIN; and a data universal numbering system number, DUNS. Site record 605 contains items such as a key linking to the respective vendor, VendorPK(FK); name of the site, Name; various addresses associated with the site, Address1, Address2, Address3, and Address4; and other information regarding the location associated with the site such as city, state, zip code and county; information regarding the status of the vendor, EffectiveStatus; an identification of the site according to the ERP system, ERPSiteID. Additionally, in one implementation site record 605 includes information such as a representation of the degree to which the respective entry in record site 605 matches a respective entry in a global directory such as global directory 620. This is shown here as item PercentMatching of record site 605.

Contact information is included in record site 605. Alternatively, a link to various contacts may be included as shown with records contact 606. Such records may include a link to the respective site, SitePK(FK); a name of the contact, ContactName; an effective status of such contact, EffectiveStatus; a title for the contact, ContactTitle; an email address for the contact, ContactEmail; and an identification as provided by the ERP system, ERPContactID.

According to one implementation a record associated with an account has respective information regarding the account such as the associated site, SitePK(FK); a link to the respective bank, BankPK(FK); the account number, AcctNum; currency used by the account, Currency; type of account, AcctType; account name, AcctName; and an identification of the account according to the ERP system, ERPAcctID. Record bank 608 has information stored regarding the bank such as link to the associated site, SitePK(FK); a routing number, RoutingNum; name of the bank, BankName; identification of the bank according to the ERP system, ERPBankID.

Each record supplier list 604 represents a site payment identity. A record supplier list 604 includes, in one implementation a link to the respective buyer company, BuyerCompanyPK(FK), which here would be a link to company 1; a link to the respective supplier site, SupplierSitePK(FK), which would be a link to record site 605; and a link to the payment identification of the supplier in the global directory, SupplierPID. For example, a record of supplier list 604 would be linked to a single pay identity of global directory 620, such as pay identity 611. Another record supplier list 504 may link to a different pay identity in global directory 620, such as pay identity 619 of company 4 618. In this manner, different sites in company 251's supplier list are linked to respective different entries within global directory 620. Similarly, respective entries from other companies' supplier lists are linked to respective entries in global directory 620. For example, here, company 3 616's supplier list 617 is shown linked to pay identity 619 of company 4 618.

Global directory 620 includes groupings of information associated with various entities, such as vendor companies. For example, here company 2 609 and company 4 618 are shown in global directory 620. A large set of entries regarding various vendors or other entities are stored optionally in global directory 620. Records in global directory 620 have information about the respective companies such as information associated with payment. For example, record company 2 609 has root company 2 610 associated with multiple records payment identity 611. Payment identity 611 represents the aspect of the entity to which payment is made. For example, payment identity may represent a department at the vendor to which certain kinds of payments are made and the associated account. Thus, in this implementation shown, record payment identity 611 includes links to various additional items of information such as pay ID aliases 612 and preference 613. Preference 613 is associated with multiple records address 614 and account number 615.

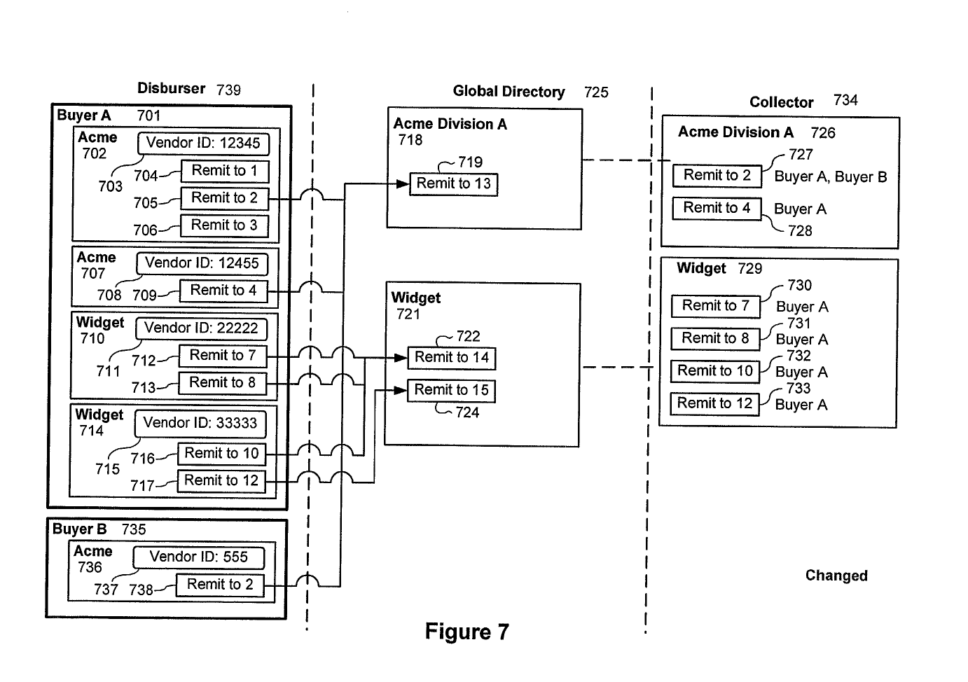

FIG. 7 is a block diagram showing address relationships according to an embodiment of the invention. Various addresses used by buyers to pay their suppliers are associated with different or similar addresses updated by vendors on the respective global directory 725. As shown in FIG. 7, respective “remit to” addresses in disburser 739 are linked to respective addresses in global directory 725. In one embodiment of the invention, a “remit to” address is a physical address, such as a postal address to which payment may be made, or at least a physical address associated with a particular kind of payment. Vendors store addresses corresponding to these physical addresses. Such addresses stored by the vendors which correspond to those stored by the customers may be different. Discrepancies may be due to different ways the same address is typed, e.g., “CA” versus “California.” Alternatively, discrepancies may arise when vendors update their address and customers have not updated their corresponding “remit to” addresses that are linked to the vendor's address in the global directory. An advantage of the approach shown is that vendors can update information in the global directory 725 and make it readily available to customers. For example, a vendor may change its account number. Later this changed account number is used to effect payment from a buyer. In one embodiment of this invention, buyers do not have access to vendor account numbers, but vendors can make their accounts available for payment by the system through use of a global directory, where such information is not visible to the customer.

Various buyers in disburser 739 have records for vendors with whom they conduct transactions. For example, buyer A 701 has associated vendor records Acme 702, Acme 707, Widget 710 and Widget 714. Buyer B 735 has vendor Acme 736. The respective vendor records include identification numbers for the respective vendor and different “remit to” addresses. As shown, record Acme 702 includes vendor ID 703 and “remit to” addresses 1-3 (704, 705 and 706). Record Acme 707 includes vendor ID 708 and “remit to” 4 709. Record Widget 710 includes vendor ID 711, “remit to” 7 shown as 712, “remit to” 7 shown as 713. Record Widget 714 includes vendor ID 715, “remit to” 10 shown as 716 and “remit to” 12 shown as 717. Buyer B 735 includes record Acme 736 with vendor ID 737 and “remit to” 2 shown as 738.

Respective addresses among these addresses are linked to addresses in global directory 725. For example, “remit to” 2 shown as 705 is linked to “remit to” 13 shown as 719 in record Acme division A 718 of global directory 725. Similarly, “remit to” 4 shown as 709 and “remit to” 2 shown as 738 of Acme 736 is linked to “remit to” 13 shown as 719. Thus, buyer 701 has separate entries Acme 702 and Acme 707 with separate remit addresses 705 and 709 that are linked to the same remit address in the global directory, i.e., “remit to” 13 shown as 719. This same remit address is used also by a different buyer, buyer B 735, as “remit to” 2 shown as 738 is linked to “remit to” 13 shown as 719.

Record Widget 710 of buyer A 701 represents another vendor of buyer A 701. Addresses “remit to” 7 shown as 712 and “remit to” 8 shown as 713 are both linked to respective address in global directory 725, i.e., “remit to” 14 shown as 722. Also, a separate entry for Widget 714 has been made by buyer A 701 as Widget 714. Such separate entries may result from buyer failing to recognize that an entry has already been made for the respective vendor. Record Widget 714 includes another separate “remit to” address, namely “remit to” 12 shown as 717, which is linked to a different address of Widget 721 in global directory 725, namely “remit to” 15 shown as 724 In collector 734 the vendor receives information as to which “remit to” addresses have been used by respective buyers. For example, “remit to” 2 shown as 727 has been used by buyer A and buyer B, and “remit to” 4 shown as 728 has been used by buyer A. Similarly, in Widget 729 of collector 734, buyer A has used the addresses “remit to” 7 shown as 730, “remit to” 8 shown as 731, “remit to” 10 shown as 732 and “remit to” 12 shown as 733.

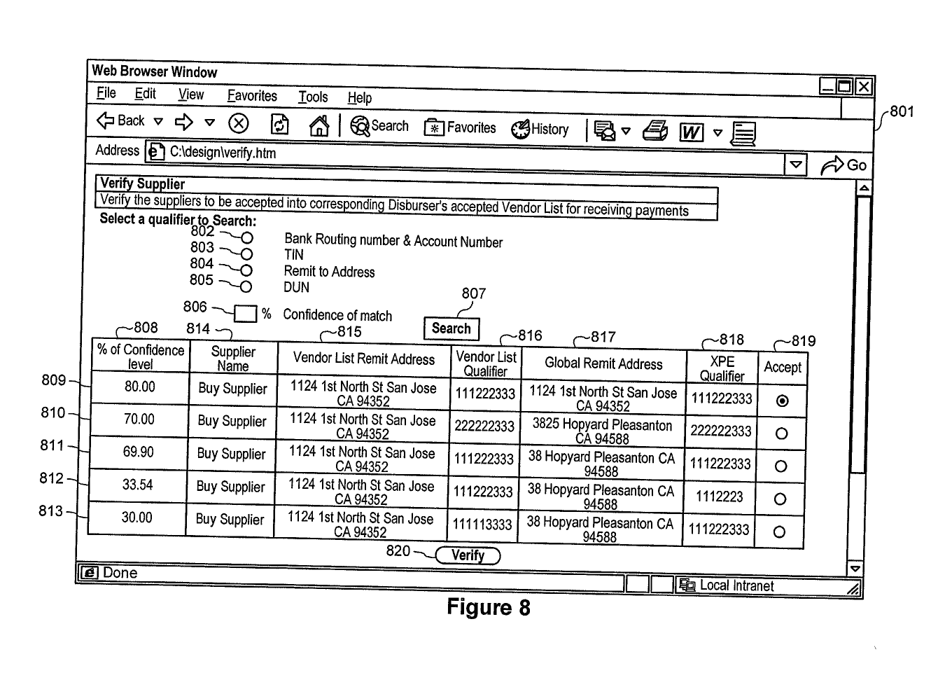

FIG. 8 is a schematic representation of a user interface according to an embodiment of the invention. According to one embodiment of the invention, links are made between matches found among (a) potential matches between information about companies, such as vendors, that is stored by one set of entities such as the customers or buyers and (b) the corresponding information about the companies, that is stored in some other location, such as a global directory. For example, customers may have address information or other payment information regarding their vendors and such information is linked to entries regarding such vendors in a global database. In one embodiment of the invention, this linking is established according to selections by the users, such as users associated with the buyer organizations. The system accepts user selections that are made based on a correspondence between (a) the addresses or other information about the vendors possessed by the user's system and (b) corresponding information in the global database.

As shown, the respective address information regarding the vendor in the buyer's database is compared with the respective address information in the global database. The system accepts a buyer's selection of which matching address in the global database is the correct address that matches the respective address stored by the buyer. Possible matches are displayed based on criteria selected by the user. For example, here, the system accepts user selection of qualifiers such as bank routing number and account number 802, taxpayer identification number (TIN) 803, “remit to” address 804, and data universal numbering system (DUNS) number 805. The system also accepts user selection of a confidence level for the match 806. In one implementation the confidence level determines a percentage level of confidence required for the respective match to be displayed. Alternatively, in another implementation, the confidence level determines the confidence level of the match required for the respective link to be made automatically.

The display is made optionally via a user interface window, such as a browser window 801. In response to the user's selection of such criteria and in response to the user's request for a search via the user's input such as search button 807, the system displays a set of possible matches, such as those shown in rows 809, 810, 811, 812 and 813. The display includes items such as the percentage confidence levels of the matches 808, the name of the supplier 814, the remit address according to the buyer's vendor list 815, an identifier of the item in the customer's vendor list 816, the respective potential matching addresses from the global remit address 817, the qualifier of such addresses in the global directory 818 and a button for acceptance of the match 819. Vendor list qualifier 816 represents a number associated with the respective entry in the vendor's own local directory. In response to the user's click of the appropriate input, such as button verify 820, the respective match is selected, and a link is established between the buyer's entry for the vendor and the respective entry in the global directory.

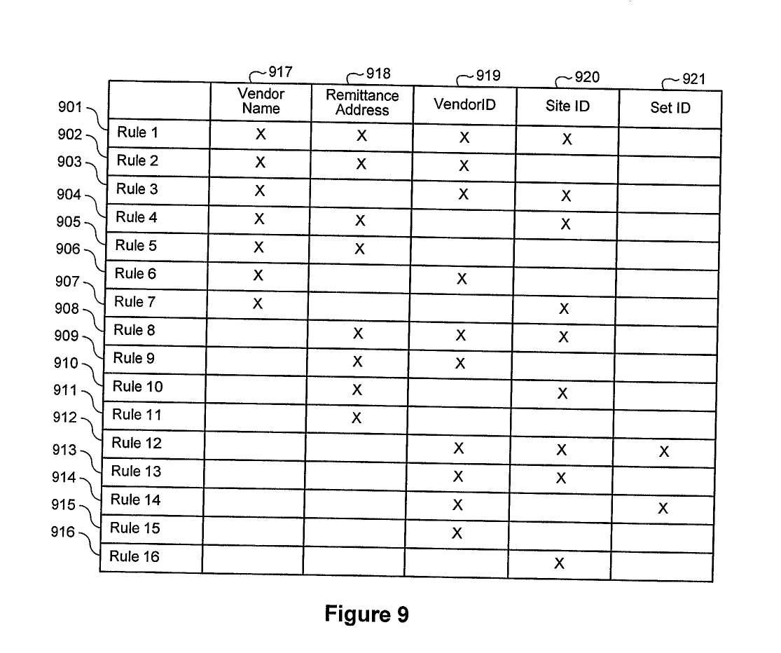

FIG. 9 is a schematic representation of a set of rules for matching identification information according to an embodiment of the invention. Various items in the respective entries for entities can be used to establish matches between such records. For example, various items of an address can be compared with other items of an address in a global directory in order to establish a link between the local and global entries. According to various embodiments of the invention, different combinations of criteria are compared. According to one embodiment of the invention, any possible combination of criteria are compared. Alternatively, a subset of possible permutations of comparisons between respective elements are provided for the user to select among. Such subcombinations may be presented as a possible set of rules.

FIG. 9 shows one possible set of rules, according to one embodiment of the invention. Each rule represents a set of the respective aspects of the address or record that are compared between the customer's record and the global record in order to establish a possible match. As shown here, rules 1-16 (items 901-916) make various combinations of the items shown above in the respective columns 917-921, which are vendor name, remittance address, vendor ID, site ID and set ID. An “X” in the respective box means that the rule includes such criterion in the column above. These rules may be presented as alternative rules among which the system allows the user to select. In one implementation the system optionally sets links depending on the matches found based on the selected rules.

Alternatively, the rules are used to select potential candidates for links as a set of candidate matches. Other criteria other than the specific ones shown are used alternatively according to other embodiments of the invention. For example, according to various implementations, subportions of an address, such as the street, zip code, city name or other information are used separately in different rules to determine matches and linking.

The matches between the respective subcomponents of records such as vendor name, remittance address, vendor ID, site ID, and set ID may be weighted differently in determining overall confidence of the match depending on the confidence the respective subcomponent gives to the match. The selection of a rule may be made based on a history within a particular vendor of success of use of the respective criteria for matching. For example, if a DUNS number match tends to provide a high level of competence of the respective match, a customer may use a rule which includes the DUNS number, possibly with a high weight compared to some other criteria.

In one embodiment, the following attributes have the following weights:

| | |
|---|---|
| Account number: | 50% |
| TIN: | 5% |
| DUNS: | 5% |
| Vendor Name: | 20% |
| Postal zip code: | 10% |
| Street Number: | 5% |
| Street Name: | 3% |
| Street address line 3: | 2% |

The system can be implemented to adjust these attributes and weights proportionally based on number of attributes presented. According to another implementation, weights substantially similar to those shown above may be used, such as weights with variances +/−20% from the weights shown. For example, a weight of 8% may be used for postal zip code. The other weights, which also may vary within similar ranges, are adjusted proportionally.

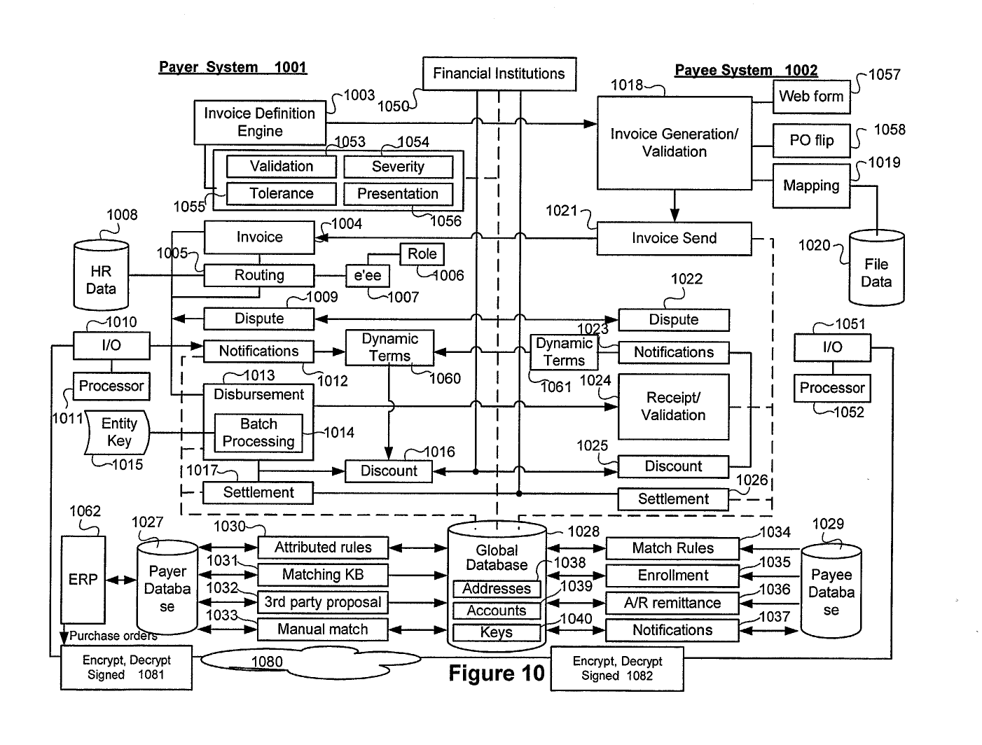

FIG. 10 is a block diagram of a system according to an embodiment of the invention. The system allows a paying entity to define the invoice format for invoices it wishes to receive. The system facilitates routing, editing, dispute resolution, and disbursement of payment. The system includes payer (buyer) shown as 1001, payee (vendor) shown as 1002, and financial institutions shown as 1050. The system has the following characteristics according to one implementation: collaborative network model, A/P (buyer) centric enterprise software, plugging into existing ERP systems, full cycle bill-to-pay functionality, web-based A/R (vendor) software, and co-existence with the customer existing bank relationships.

The collaborative network model supported by the unique collaborative vendor reconciliation engine between global directory shown as 1028 and A/P centric master vendor list shown as 1027. The reconciliation engine provides methods of matching existing vendor name/address with self enrolled vendor information in the global directory. These methods include: fuzzy attributed weight based matching shown as 1030, previous vendor histories of matching in the knowledge based shown as 1031, third party outsourced recommended matching proposal shown as 1032, and manual interactive selection from buyers shown as 1033. Each vendor is represented by several critical attributes in the global directory: addresses shown as 1038, real and alias accounts shown as 1039, and keys shown as 1040. Vendor entries are pre-populated with information uploaded from the buyer ERP system. The vendor enrolls via the online self-service enrollments 1035. Vendor also provides additional rules to match 1034, A/R remittance format attributes 1036, and notification rules/addresses 1037.

Accounts payable (A/P) buyer-centric enterprise software associated with payer system 1001 includes several key unique functions. These functions include buyer defined electronic invoice exchange, routing/editing and approval, and dispute resolution. Payer system 1001 includes invoice definition engine 1003, invoice 1004, HR organization data 1008, routing/editing logic 1005, dispute logic 1009, notifications logic 1012, disbursement logic 1013, dynamic terms logics/offers 1060, discount logic 1016 and settlement logic 1017. Also included on payer system 1001 are input output (I/O) 1010, processor 1011, entity key 1015, and payer central repository database 1027. The invoice definition engine 1003 includes validation logic 1053, tolerance/replacement items 1055, interaction severity 1054, and several presentation forms 1056. This definition engine is controlled by payer helps provide clean invoice data from payees. The definition logics (1053, 1054, 1055, and 1056) can be configured to specific payee or a specific group of payees.

Invoice definition engine 1003 and its definition logics are exposed to payee via global directory and are operative with invoice definition/generation/validation 1018 of payee system 1002. The routing/editing logic 1005 includes business logic that governs how an invoice will be processed by AP clerks, and what data entry information will be required to complete the transaction. Routing/editing logic 1005 can operate differently based on multiple attributes: document type, document value, discount value, etc. Routing/editing logic 1005 acts on HR organization database 1008 to define routing/editing/approval work flow based on employee information 1007 and role values 1006. Invoice 1004 is coupled into routing logic 1005. Routing logic 1005 is coupled with employee logic 1007 and role assignment 1006. Routing logic 1005 is coupled with HR data 1008 and with dispute logic 1009, notifications logic 1012 and disbursement logic 1013 of payer system 1001. Notification logic 1012 is configured by the payer, and includes collaborative filtering, and mappings status and notification definitions between internal to external payees. These collaborative filtering and mappings can be designated to a payee or a group of payees.

Dispute logic 1009 is set of payer defined centric collaboration rules and interactions between payer and payee to resolve issues related to invoice or other exchanged documents. Some disputes are simple (e.g., number of items is received, etc.) while others are more complex (e.g., replacement items do not meet part specification and price). The outcomes of a dispute are partial payments, partial invoices, new invoices, or other outcomes. According to one implementation, a dispute can only be finalized by payer and its members, and some finalized exchanges will require digital signature to ensure non-repudiation. The payer dispute logic 1009 orchestrates with payee dispute logic 1022. Payer dispute logic, references, and history are stored in payer central repository 1027.

A/R web based centric software associated with payee system 702 helps provide an online self-service payee system. Payee system 702 includes a processor 1052 and input/output (I/O) 1051. Such processor 1052 and input/output 1051 allow for communication with other entities such as payer system 1001, financial institutions 1050 and global database 1028. Processor 1052 and processor 1011 of payee 1002 and payer 1001 respectively may run various software processes to implement the logic shown. The processes may be implemented as software objects, routines or other software processes, programs or implementations. Alternatively, portions of such logic may be implemented in hardware logic or other forms of logic. The functions shown may alternatively be implemented on a common server or in a distributed set of computer systems separated over a computer network, or other configuration that achieves the logical functions shown. Data and information such as for global database 1028 may be stored in data structures or other data format and stored in computer memory, fixed storage or other data storage or archived in various implementations of the invention.

Payee system 1002 includes invoice generation/validation logic 1018, invoice send logic 1021, dispute logic 1022, notifications logic 1023, receipt/validation logic 1024, discount logic 1025 and settlement logic 1026. Invoices or other documents can be submitted to payer via multiple mechanisms. Three sample mechanisms are shown here: Web forms shown 1057, purchase order pre-populated invoice (PO flip) 1058, and electronic file submission via file mapping 1019. The Web forms 1057 are a set of payer defined presentations that can be selected and/or authorized to be used by payee(s). Payee can also define additional payee private attributes and fields to be used during A/R matching as well as graphic materials (such as company logo, etc.). The PO flip 1058 uses information from purchase orders which are transmitted to payee from payer to pre-populate the invoice data. The status of each purchase order is maintained within the payee central repository to support blanket purchase orders. File mapping 1019 is used by the payee to automate the bulk invoice submission process. Normally, these file are exported from payee's A/R system. The mapping defines how payee's data will be mapped into payer, as well as default/validation/transformation rules. Upon submission of these invoices or other documents via multiple mechanisms (1057, 1058, 1019). The documents are validated based on the payer definition engine 1018. This definition engine 1018 includes payer definition engine 1003 and its components: validation 1053, severity 1054, tolerance 1055 and presentation 1056.

Invoice generation/validation logic 1018 is coupled with mapping logic 1019 in communication with file data 1020. Invoice generation/validation logic 1018 is coupled into invoice send logic 1021. Dispute logic 1022 is coupled with dispute logic 1009 of payer system 1001. Notifications logic 1023 is in communication with notifications logic 1012 of payer system 1001 and discount logic 1025 of payee system 1002. Receipt/validation 1024 of payee system 1002 is in communication with disbursement module 1013 of payer system 1001. Settlement logic 1026 is operative with discount logic 1025 of payee system 1002 and receipt/validation logic 1024.

Global database 1028 is available to notifications logic 1012 and 1023, disbursement logic 1013, settlement logic 1017 and 1026, invoice send logic 1021, receipt 1021 and receipt/validation logic 1024. Global database 1028 is in communication with payer database 1027 through attribute match rules 1030, knowledge based history matching samples 1031, third party recommendation/proposal 1032 and manual interactive matching by payers 1033. Global database 1028 is in communication with payee database 1029 through match rules 1034, enrollment logic 1035, remittance formats 1036 and notification preferences 1037. Global database includes items such as address 1038, accounts 1039 and public keys 1040. Payer database 1027 is located with payer system 1001 and payee database 1029 is located with payee system 1002. Global database 1028 is also available to financial institutions 1050.

Through invoice definition engine 1003 a payer uses payer system 1001 to define the invoice that the payer wishes to receive. Such definition helps to increase efficiency in the payer system because the resulting invoice from the payee, such as a seller, is more likely then in the proper data format when it is received. Payee system 1002 generates an invoice based on the defined invoice in invoice generation/validation logic 1018. The input data for the invoice is validated based on the invoice definition rules defined in payer system 1001. If file data is used to automatically map into an invoice, such mapping is performed in one embodiment of the invention by mapping logic 1019. Mapping logic 1019 receives the file data 1020 with information to be populated into respective invoices. File data 1020 may contain files with data for invoices for various payers who have purchased good or services from the payee. When an invoice is completed it is sent through invoice send logic 1021 to payer system 1001. Additional information regarding definition of invoice by the buyer and use of related invoice rules is contained in United States patent application entitled System and Method for Electronic Payer (Buyer) Defined Invoice Exchange, application Ser. No. ______, invented by Duc Lam, Ramnath Shanbhogue, Immanuel Kan, Bob Moore and Xuan (Sunny) McRae, attorney docket number 25923.706, which is incorporated herein by reference in its entirety.

An invoice is received at payer system 1001 as shown here with invoice 1004. The invoice is routed to the respective employees or other agents for its review and approval. Some approval may require additional signatures according to one embodiment of the invention. As shown here, employee logic 1007 is in communication with routing logic 1005 to allow an employee to authorize, audit or view respective invoice or check information.

Routing logic 1005 is also used to route checks or other documents to various employees for signature or approval using HR data 1008. Routing logic 1005 uses HR data 1008 to determine the correct employees to whom to route the respective document, such as in an invoice or check. Routing may be made to the manager of a respective employee if the employee has not responded in a certain time to the document. Such the choice of such manager to whom to route is made based on the management hierarchy in the organization stored in HR database 1008. Such database is extracted from a human resource management system (HRMS), in one implementation of the invention. Additional information regarding routing of documents in the system is described in United States patent application entitled Method and System for Invoice Routing and Approval in Electronic Payment System, application Ser. No. ______, invented by Bob Moore and Xuan (Sunny) McRae, attorney docket number 25923.707, and which is incorporated herein by reference in its entirety.

A user of payer system 1001 may dispute an invoice or other payment request through dispute logic 1009. Dispute logic 1009 is in communication with dispute logic 1022 of payee system 1002. This allows for communication regarding a dispute between a payer and a payee. The dispute may be only initiated and finalized by a payer. According to one embodiment of the invention, the dispute may be finalized only by the buyer, or the payer system. The dispute includes the capability to indicate that particular items in an invoice are disputed, such as the tax. The dispute logic 1009 and 1022 include the capability for individuals using the payer system 1001 using payee system 1002 to engage in a chat dialog. For additional discussion regarding electronic dispute resolution in such a system, refer to United States patent application entitled Method and System for Buyer-Centric Dispute Resolution in Electronic Payment System, application Ser. No. ______, invented by Duc Lam, Celeste Wyman and Xuan (Sunny) McRae, attorney docket number 25923.708, which is incorporated herein by reference in its entirety.

Notifications logic 1012 communicates completion of various stages of approval or other issues of status regarding invoices and disbursement. For example, when an invoice is approved notifications logic 1012 communicates a notification to notifications logic 1023 of payee system 1002. Based on such notifications, a discount may be enabled through discount logic 1016, which is in communication with discount logic 1025 of payee system 1002. For example, where an invoice is approved, a discount may be enabled based on an agreement or outstanding dynamic terms offers shown as 1060 that the corresponding payment is made earlier than required under the original terms and conditions. Dynamic terms are additional real-time terms, a set of rules, and/or goal seeker that are established by payer 1060 or payee 1061. These dynamic terms rules 1060 and 1061 are based on business event types (invoice approval, purchase order approval, etc.), a payee or group of payee and a set of new discrete or variable terms. These dynamic term goal seekers allow payer and payee to set desirable outcomes. These dynamic terms can be pre-negotiated up-front or in real-time based on business event types. The approval of these new terms may require digital signature of either payer or payee. Also, third party financial institutions could be involved to provide finding for payee in returns for early discounts. For additional information regarding discounts facilitated by the system, dynamic terms (1060 and 1061) and discount logic 1016 and 1025 please refer to US patent application entitled System and Method for Varying Electronic Settlements between Buyers and Suppliers with Dynamic Discount Terms, application Ser. No. ______, invented by Don Holm, Duc Lam and Xuan (Sunny) McRae, attorney docket number 25923.705, which is incorporated herein by reference in its entirety.

To facilitate complete bill-to-payment functionality, the system in FIG. 10 includes disbursement logic 1012 and settlement logic 1017. Disbursement logic 1013 includes all payment routing, signing, and approval logic for respective invoices or other requirements for payment. Some payments will require multiple signatures to be signed based on payment amount and/or destination payee(s). Digital signatures and nondigital signatures may both be used. Also, payer can configure to control new settlement date for the payment by defined payee group and number of business/calendar days to be adjusted. The disbursement logic also includes auditing capability with multiple levels based on number of signatures and/or amount. In one implementation, disbursement logic 1013 makes such disbursement in the form of electronic checks in one implementation. Such electronic checks are generated and signed with a digital signature. The digital signature may be obtained from respective users such as through a routing process using routing logic 1005 to obtain a signature from employee logic 1007 with role assignment digital key 1006.

Alternatively, a set of instructions may be received to send a set of checks that use a digital signature of the payer organization rather than the digital signature of an employee. Such check processing may be accomplished through batch processing logic 1014 and disbursement logic 1013. Such batch processing logic 1014 uses an entity key 1015, which is a private key of the payer's organization. Batch processing logic 1014 requires particular authorization for the respective instruction. The authorization may require that the agent requesting the set of checks sign the instruction with the agent's private key. Receipt/validation logic of payee system 1002 is in communication with disbursement logic 1013. Receipt/validation logic 1024 receives payment, such as in the form of electronic checks. Such electronic checks are validated to assure that they are accurate. Receipt/validation logic decrypts any encrypted documents, for example if the electronic checks are encrypted with the public key of payee system 1002, such checks are decrypted. Additionally, the digital signature of the sender is authenticated in receipt/validation logic 1024. Such authentication is accomplished using the public key of the payer, which corresponds to the private key of the payer's organization (entity key 1015) that was used in batch processing logic 1014 (entity key 1015). Additionally, verification may be made against a payment database generated by the payer system when the checks are created in order to assure that the checks were actually sent by the payer system. Additional information regarding disbursement 1013 and batch processing 1014 is contained in United States patent application entitled System and Method for Electronic Authorization of Batch Checks, application Ser. No. ______, invented by Duc Lam, Matthew Roland and Xuan (Sunny) McRae, attorney docket number 25923.704, which is incorporated herein by reference in its entirety.

Settlement logic 1017 allows for settlement of payment between a payer system 1001 and payee system 1002. Settlement mechanism includes exiting combination of paper based checks, standard domestic electronic payment network (Fed Wire, ACH, CHIPS, etc.), international electronic payment networks (SWIFT, Bolera, etc.), propriety private payment networks (VISA, MasterCard, and American Express, etc.), and internal account bank transfer (On-us, etc.) For example, settlement may be made through debits and credits in a database within the system. Alternatively, settlement may be performed through an external network such as the ACH network with financial institutions involved, such as financial institutions 1050.

Settlement logic 1017 supports standard fund transfer model (buyer's account will be debited and supplier's account will be credited.) and good funds model (buyer's account will be debited and a temporary account will be credited. Upon receiving fund availability in temporary account, the supplier will be credited). Settlement logic 1017 is implemented via issuing requests to the settlement network. Such request can be file-based requests such as ACH or transactional request such as VISA networks. For each request, there will be associated confirmation ID to ensure the trace ability of each transaction.

Global database 1028 is available for use by elements that send payment, such as disbursement logic 1013 and settlement logic 1017. Global database 1028 is also available for elements that send other documents or information between payees and their respective financial institutions. For example, invoices may be sent based on the respective recipient address as stored in the global database 1028. Thus, invoice sends logic 1021 is in communication with global database 1028.

Global database 1028 includes addresses and account information for respective payers and payees who use the system. Links are created between items in the global database and other databases in order to allow for the global database to be updated and the corresponding linked information to continue to be used. Thus, for example, according to one embodiment of the invention, a payer has a separate database, payer databases 1027, and matches are created between items, such as addresses or payment entities and payer 1027 and respective items in global database 1028 through a match generation process 1030. Such matched generation process 1030 may include providing a user of the payer system 1001 with a series of candidate matches between addresses stored on payer database 1027 and corresponding spellings of addresses or payment entities in global database 1028. The user of payer system 1001 is then able to select the best match and create a link between the respective address or payment identification.

This link can then later be used to effect payment to the proper address as stored in the global database. Similarly, a match generation between items in payee database 1029 and global database 1028 can be performed so that payee system 1002 can send items to the proper recipient using information in global database 1028. Enrollment logic 1035 is available to enroll new entities as payees into the global database to make them available for use by payer system 1001 or payee system 1002.

The links established are then available to allow for use of information in the respective payer database 1027 and payee database 1029 in order to find recipients to whom documents or payments are to be sent. In addition to address information 1038 and account information 1039, according to one embodiment of the invention, public keys of various participants in the systems are stored in the global database 1028. Such keys are then available for use in order to determine the accuracy of a digital signature sent by a particular entity.

In the FIG. 10 system, invoices and other documents are exchanged between payers and payees over the public and internet networks 1080. To help provide security and privacy, before they are sent, invoices and other documents are signed with source private key, and encrypted with destination public key shown as 1081. Upon receiving invoice or other document, the document is decrypted with its own private key, and validated against source public key to ensure non-repudiation shown as 1082.

The system also can integrate with multiple enterprise resource planning (ERP) systems shown as 1062. Such ERP systems include: PeopleSoft, SAP, Oracle Financials, etc. The system will integrate with these ERP systems via native and/or standard interfaces. An example of native interface for PeopleSoft is Message Agent, etc. The interfaces include EDI gateway, etc. The system utilizes the ERP to extract documents (purchase orders, invoice status, unit of measurements, vendor list, etc.), to post documents (invoices, vendor information, status, etc.).

The foregoing description of various embodiments of the invention has been presented for purposes of illustration and description. It is not intended to limit the invention to the precise forms described.

What is claimed is:

1. A method of exchanging business documents between a set of entities, the set including a plurality of buyers and sellers, the method comprising:
receiving identification information from respective entities, the identification information including at least the names of the respective entities from which the identification information is received;
storing the information received from the entities in records in a first storage resource, the records including information to facilitate sending documents to the entities;
based on similarity between information in respective records, determining approximate correspondence between records in (a) the first storage resource and (b) a second storage resource, wherein the second storage resource is included in an enterprise resource planning (ERP) system belonging to a first entity;
establishing links between the respective records based on the approximate correspondence;
receiving a request to send a document from the first entity to a second entity;
identifying a record associated with the second entity in the second storage resource in the enterprise resource planning system;
based on the established link between the record associated with the second entity and a corresponding record in the first storage resource, obtaining information in the corresponding record in the first storage resource to facilitate sending the document to the second entity; and
sending the document from the first entity to the second entity based on the information in the corresponding record in the first storage resource.

2. The method of claim 1, wherein the information received from respective entities includes a postal address and account information.

3. The method of claim 2, wherein determining approximate correspondence comprises determining degree of correspondence between the postal address and name in the first storage resource and the postal address and name in the second storage resource.

4. The method of claim 1, wherein the information to facilitate sending documents comprises an electronic mail address of the respective entity.

5. The method of claim 1, wherein the first entity comprises a buyer, the second entity comprises a seller and the document comprises an electronic check.

6. The method of claim 1, wherein the document comprises an invoice.

7. The method of claim 1, including,
loading records from the second storage resource onto a system separate from the enterprise resource planning system; and
comparing records loaded onto the system separate from the enterprise resource planning system with the records in the first storage resource to determine the correspondence between records in the first storage resource and the second storage resource.

8. The method of claim 1, including establishing links between the respective records based on links previously established between records in (a) the first storage resource and (b) storage devices included in enterprise resource planning (ERP) systems belonging to an entities other than the first entity and the second entity.

9. The method of claim 1, including establishing links between the respective records based on recommendations by a party other than the first entity and the second entity.

10. The method of claim 1, including establishing links between respective records based on user selection when insufficient confidence is established from automatic determination of similarity between information in respective records.

11. The method of claim 1, including determining the approximate correspondence based on a weighted combination of the correspondence between selected items in the corresponding records in the first storage resource and the second resource.

12. The method of claim 1, including,
receiving a seller's identification information from a buyer;
presenting to the seller the seller's identification information that was received from the buyer;
receiving from the seller edits to the seller's identification information;
storing the edited seller's identification information in a record in the first storage resource; and
establishing a link between a corresponding record in the buyer's enterprise resource planning system and the record the first storage resource that includes the seller's edited identification information.

13. The method of claim 12, including, after establishing the link between the corresponding record in the buyer's enterprise resource planning system and the record the first storage resource that includes the seller's edited identification information, updating the seller's identification information in the first storage resource based on input from the seller.

14. The method of claim 1, including
receiving from a buyer information regarding,
an address for billing of transactions,
an address for shipping goods in the transactions, and
a definition of an invoice to be submitted to the buyer for transactions;
storing the information from the buyer in the first storage resource; and
effecting a transaction between a seller and the buyer using the information from the buyer stored in the first storage resource.

15. A system for exchanging business documents between a set of entities, the set including a plurality of buyers and sellers, the system comprising:
a first storage resource;
logic that receives identification information from the respective entities, the identification information including at least the names of the respective entities from which the identification information is received;
logic that stores the information received from the entities in records in the first storage resource, the records including information to facilitate sending documents to the entities;
logic that, based on similarity between information in respective records, determining approximate correspondence between records in (a) the first storage resource and (b) a second storage resource, wherein the second storage resource is included in an enterprise resource planning (ERP) system belonging to a first entity;
logic that establishes links between the respective records based on the approximate correspondence;
logic that receives a request to send a document from the first entity to a second entity;
logic that identifies a record associated with the second entity in the second storage resource in the enterprise resource planning system;
logic that, based on the established link between the record associated with the second entity and a corresponding record in the first storage resource, obtains information in the corresponding record in the first storage resource to facilitate sending the document to the second entity; and
logic that sends the document from the first entity to the second entity based on the information in the corresponding record in the first storage resource.

16. A method for effecting electronic payment between a first entity and a second entity, the method comprising:
storing an account identification for the first entity;
associating the account identification with a first postal address;
receiving a request from the second entity to make payment to the first entity, the request including an identification of a second postal address which approximately corresponds to the first postal address;
associating the second postal address with the first postal address; and
effecting the payment electronically from the first entity to the account corresponding to the account identification stored for the first entity.

17. The method of claim 16, including:
providing the second entity a set of possible addresses that may correspond approximately with second postal address, the set of possible addresses including the first postal address; and
receiving a selection from the second entity of the first postal address from among the set of possible addresses;
wherein the associating the second postal address with the first postal address is performed in response to the receipt of such selection by the second entity.

18. The method of claim 16, including automatically associating the second postal address with the first postal address if a set of components of the first postal address and the second postal address match greater than a particular threshold.

19. The method of claim 16, including wherein the first postal address includes fields of:
a vendor name;
a zip code;
a portion comprising one of, (a) a street address or (b) a post office box number;
a taxpayer identification number (TIN) number; and
a data universal numbering system (DUNS) number;
wherein any of the foregoing fields may be blank.

20. The method of claim 19, wherein the first postal address further includes a field of a department name.

21. The method of claim 19, wherein the postal address further includes a field of a business unit.

22. The method of claim 19, including automatically associating the second postal address with the first postal address if a set of the fields of the first postal address and the second postal address match greater than a particular threshold.

23. The method of claim 16, including automatically associating the second postal address with the first postal address based on unstructured pattern matching.

24. The method of claim 16, including automatically associating the second postal address with the first postal address based on fuzzy of the rules matching set of fields.

25. The method of claim 16, including
providing the second entity a set of possible addresses that may correspond approximately with second postal address, the set of possible addresses including the first postal address, and the set of possible addresses selected including addresses in which particular set of fields match the second postal address greater than a particular threshold; and
receiving, from the second entity, a selection of the first address from among the set of possible addresses.

26. The method of claim 25, automatically associating addresses based on unstructured pattern matching.

27. The method of claim 25, wherein the providing the set of possible addresses is based on fuzzy rules of matching a set of fields of the first postal address and the second postal address.

28. The method of claim 16, including
providing the second entity a set of possible addresses that may correspond approximately with second postal address, the set of possible addresses including the first postal address,
for each address in the set of possible addresses, providing a level of confidence in correspondence between the respective address and the second postal address; and
receiving, from the second entity, a selection of the first address from among the set of possible addresses.

29. The method of claim 16, including effecting payment with an electronic check.

30. The method of claim 29, wherein the check includes a digital signature.

31. A method for effecting electronic payment between a first entity and a second entity, the method comprising:
receiving from the first entity an account number identifying a financial account of the first entity;
receiving a first postal address provided by the first entity and associated with the account number by the first entity;
storing the account number and the first postal address in a record associated with a first unique identifier;
receiving from the second entity a second postal address which approximately corresponds to the first postal address;
storing the second postal address in a record with a second unique identifier;
receiving a request from the second entity to make payment to the first entity, the request including an identification of the second postal address;
determining that the first postal address corresponds to the second postal address;
based on such determination, associating the first unique identifier with the second unique identifier; and
effecting the payment electronically from the first entity to the financial account of the first entity identified by the account number.

32. The method of claim 31, including
receiving, from the first entity, a request to change the account number to a second account number associated with a second financial account in the record associated with a first unique identifier;
in response to the request to change, changing the account number to the second account number, in the record associated with a first unique identifier;
after such changing, receiving a second request from the second entity to make payment to the first entity, the request made based on identification of the second postal address; and
effecting the payment electronically from the first entity to the second financial account of the first entity identified by the second account number.

33. A system for effecting electronic payment between a set of entities associated with vendors and a set of entities associated with purchasers, the system comprising:
a database including,
for a respective entity associated with a purchaser, a set of records including remittance addresses of vendors,
for a respective entry associated with a vendor, a set of records each including a remittance address and an identifier of a financial account, and
links between (a) the respective records for the entity associated with the purchaser and (b) the respective records associated with vendors, the links linking records with corresponding remittance addresses;
computer readable code that establishes the links based on correspondence between the respective addresses in the respective records for the entity associated with the purchaser and the respective entities associated with vendors;
computer readable code that receives a request from an entity associated with a purchaser to make payment to a vendor, the request including a selection of a remittance address from among the respective records for the entity associated with the purchaser;
computer readable code that effects payment to a financial account based on the link between (a) the respective record for the entity associated with the purchaser, the record corresponding to the selected remittance address and (b) the respective record for the entity associated with the vendor, the record having a remittance address corresponding to the selected remittance address and an identifier of the financial account.

34. The system of claim 33, wherein the database includes a first database with respective entries associated with the vendor located on a server, and two databases associated with respective entries associated with the purchaser, the first such database is located on the server, and the second such database is located on the purchaser's Enterprise Resource Planning (ERP) system.

35. A method for effecting an electronic financial transaction between a first entity and a second entity, the method comprising:
storing an payment identification for the first entity;
associating the payment identification with a public identification of the payment identification;
receiving a request from the second entity to make payment to the first entity, the request including a second public identification of the payment identification which approximately corresponds to the first public identification;
associating the second public identification with the first public identification; and
based on such associating, effecting the payment electronically from the second entity to first entity in accordance with the payment identification for the first entity.

36. A system for effecting electronic payment between a set of entities associated with vendors and a set of entities associated with purchasers, the system comprising:
a database including,
for a respective entity associated with a purchaser, a set of records including public payment identifications of vendors,
for a respective entry associated with a vendor, a set of records each including a public payment identification and a payment identification, and
links between (a) the respective records for the entity associated with the purchaser and (b) the respective records associated with vendors, the links linking records with corresponding public payment identifications;
computer readable code that establishes the links based on correspondence between the public payment identifications in the respective records for the entity associated with the purchaser and the respective entities associated with vendors;
computer readable code that receives a request from an entity associated with a purchaser to make payment to a vendor, the request including a selection of a public payment identification from among the respective records for the entity associated with the purchaser;
computer readable code that effects payment to in accordance with the payment identification based on the link between (a) the respective record for the entity associated with the purchaser, the record corresponding to the public payment identification and (b) the respective entity for the entity associated with the vendor, the record having a public payment identification corresponding to the selected public payment identification and a payment identification.

37. A system for effecting electronic payment between a set of entities associated with vendors and a set of entities associated with purchasers, the system comprising:
a server;
a first database coupled with the server including, for a respective entity associated with a purchaser, a set of records including public payment identifications of vendors,
a second database coupled with the server including, for entries associated with vendors, a set of records each including a public payment identification and a payment identification;
links between (a) the respective entries in the first database and (b) respective entries in the second database, the links linking records with corresponding public payment identifications;
computer readable code that establishes the links based on correspondence between the public payment identifications in the respective records in the first database and the second database;
computer readable code that receives a request from an entity associated with a purchaser to make payment to a vendor, the request including a selection of a public payment identification from among the respective records for the entity associated with the purchaser; and
computer readable code that effects payment to in accordance with the payment identification based on the link between (a) the respective entry in the first database and (b) the respective entry in the second database, the entry in the second database having (i) a public payment identification corresponding to the selected public payment identification and (ii) a payment identification.

38. The system of claim 37, including computer readable code that synchronizes entries in the first database with entries in a third database coupled to a purchaser's enterprise resource planning (ERP) system.

39. The system of claim 37, including computer readable code that generates matches between entries in the first database and the second database based on correspondence between public payment identifications in the respective entries.

40. The system of claim 37, including computer readable code that enrolls entries in the second database from the first database.
